(19) United States
(12) Patent Application Publication
(10) Pub. No.: US 2006/0201395 A1
(43) Pub. Date: Sep. 14, 2006

(54) Blended fly ash pozzolans

(76) Inventors: Gregory S. Barger, Overland Park, KS (US); Charles T. Wiedenhoft, Overland Park, KS (US)

Correspondence Address: Wm. Bruce Day;DAY LAW FIRM, P.C., 4330 Belleview, Suite 300, Kansas City, MO, 64111-3579, US

(21) Appl. No.: 11/076,096

(22) Filed: Mar. 8, 2005

(51) Int. Cl. C04B 18/06; C04B 28/04; C04B 7/14

(52) U.S. Cl. 106/705; 106/713; 106/715

(57) ABSTRACT

Novel premium blended pozzolans for use with hydraulic cement are created by intergrinding an ASTM Class F or Class C coal fly ash and a source of calcium sulfate, such as gypsum, so that the resultant mixture has a fineness of at least 90% passing through a 45 micron sieve. The novel mixture meets the requirements of ASTM C 618. Alternately, a novel concrete composition can be formed using the blended pozzolan with a hydraulic cement, aggregate and water so as to produce a concrete having improved strength, ASR mitigation, improved sulfate resistance and lowered permeability. The novel pozzolans not only reduce production costs by decreasing fuel and raw material consumption per ton of cement, but they also use by-product waste materials from another industry to create a premium product for the construction industry.

### FIELD OF THE INVENTION

This invention is related to novel pozzolans for use in mixing with hydraulic cement to make concrete. Concretes prepared from the improved pozzolans of this invention exhibit unprecedented and unexpected characteristics of improved strength, ASR mitigation, improved sulfate resistance and lowered permeability. Cementitious systems of this invention are substituted in place of ordinary Portland cements as referenced in ASTM C 150-04, as well as compliant to ASTM C 1157-04 and C 595-04.

### BACKGROUND OF THE INVENTION

In the United States, cements are divided into the following categories: (1) Portland cement; (2) Natural cement; (3) High alumina cement; (4) Supersulfate cement; and (5) Special cements. This invention is generally related to an improved blended pozzolans for use in blended or masonry cements as a premium additive to ordinary Portland cement.

To assist the reader in understanding the processes and compositions of this invention, a listing of terms and their basic definitions is set forth below, as well as a basic description of how ordinary Portland cement is prepared and tested. This information is not supplied as a limitation to the invention and should not be used as such. The scope and breadth of the invention is set forth in the claims.

A. Definitions

Ordinary Portland cement is a hydraulic cement produced by pulverizing Portland cement clinker. Portland cements are classified under ASTM standards (C 150-04) into eight types, including:

Type I. For use in general concrete construction where the special properties specified for Types II, III, IV and V are not required.

Type II. For use in general concrete construction exposed to moderate sulfate action, or where moderate heat of hydration is required.

Type III. For use when high early strength is required.

Type IV. For use when low heat of hydration is required.

Type V. For use when high sulfate resistance is required.

Type IA, IIA and IIA are the same as Types I, II, and III respectively except that they have an air entraining agent added. “Ordinary Portland cement” in the context of this patent covers all types (I-V and IA-IIIA) of Portland cement as referenced in ASTM C 150-04.

Cement clinker is the sintered product produced by the kiln system. In ordinary Portland cement, the clinker is generally a partially fused product consisting essentially of crystalline hydraulic calcium silicates.

Blended cement is generally a hydraulic cement comprising an intimate and uniform blend of ordinary Portland cement and pozzolanic materials produced by (1) intergrinding ordinary Portland cement clinker with the pozzolanic materials; or (2) interblending ordinary Portland cement with the pozzolanic materials.

Fly ash is the finely divided residue that results from the combustion of ground or powdered coal. It does not include garbage burning or other “incinerator ash.” Class F fly ash is normally produced from burning anthracite or bituminous coal and has pozzolanic properties. Class C fly ash is normally produced from lignite or subbituminous coal, and as it has lime content, has both pozzolanic properties and some cementitious properties. Fly ash is referenced in ASTM C 618.

Masonry cement is a hydraulic cement for use as mortars for masonry construction. It contains one or more of the following materials: ordinary Portland cement, Portland blast-furnace slag cement, Portland-pozzolan cement, natural cement, slag cement or hydraulic limes. It also usually contains one or more materials such as hydrated lime, limestone, chalk, calcareous shell, talc, slag or clay.

Hydraulic cement is a cement that sets and hardens by chemical interaction with water and is capable of doing so under water.

A cementitious system is the total combined dry mixture of finely divided hydraulic and pozzolan materials which reacts with water to form the binder in concrete.

Concrete is a construction material comprised of the cementitious system, water, admixtures, and aggregates.

Pozzolan is normally a siliceous or siliceous and aluminous material, which in itself possesses little or no cementitious value, but will, in finely divided form and in the presence of moisture, chemically react with calcium hydroxide at ordinary temperatures to form compounds possessing cementitious properties.

Blended pozzolan is a pozzolan blended with other components. The components may be any of several types of material, including: gypsum, alkali salts, hydrated kiln dust, hydrated lime, fly ash, plasticizing agents, etc.

To calcine or calcining a material is to alter the composition or physical state of the material by heating the material to drive off volatile matter without fusing.

Intergrinding is the process of grinding materials to a desired fineness in a grinding mill.

Interblending is a process of adding materials to the cement after the cement clinker has already been ground in the grinding mill.

Normal consistency (nc) is the amount of water required to prepare cementitious systems to a given consistency as defined by ASTM C 187-04.

Efflorescence is the mechanism by which available alkalies and lime are transported to masonry mortar surfaces and precipitate out upon drying to form a powered material. The precipitate is typically a sodium carbonate or calcium carbonate composition.

The property of low alkali functionality is defined as the equivalent performance of a cementitious system to the performance of a low alkali Portland cement when tested by ASTM C 227-04 test methods.

The property of alkali non-reactiveness is defined as when the cementitious system expands less than about 0.06% using the testing procedure of ASTM C 227-04.

The property of alkali resistance is when cementitious systems have less than a about 0.08% expansion when tested using ASTM C 1260-04 using a highly reactive aggregate. Alkali resistant cementitious systems offer protection from alkali attack far beyond that provided by low alkali functionality cementitious systems because alkali resistant cementitious systems actually protect the aggregate from attack.

A highly reactive aggregate is defined here as an aggregate that results in an expansion of about 0.6% or more under ASTM C 1260-04 using Type I Portland Cement. Highly reactive aggregates secured from other specific geographic quarry locations and which are commonly used for testing are known here as “New Mexico Aggregates” and “Canadian Spratt Aggregates.”

A. Current Day Preparation of Ordinary Portland Cement

Ordinary Portland cement is generally prepared as schematically set forth in FIG. 1. The raw materials, which are generally comprised of limestone, sand, clay and iron ore, are fed proportionally into a grinding mill. In the grinding mill, the raw materials are ground to the desired fineness. After being ground, the raw materials are fed into the rotary kiln system for calcining.

After the feed passes through the rotating kiln, it is “cement clinker” and is passed over a clinker cooler which provides air to cool the cement clinker. The cement clinker is then passed into a grinding mill wherein gypsum is interground with the cement clinker to provide the ordinary Portland cement.

After being interground with the desired proportion of gypsum, the Portland cement is moved to bulk storage. The cement is then distributed to the customer.

When preparing ordinary Portland cement under conventional theories, typical grinding mills are fed two components, cement clinker and gypsum (CaSO₄2H₂O). In the grinding mill, each component absorbs energy proportional to the amount of each component in the mill. For example, if the feed is comprised of 94% clinker and 6% gypsum, the clinker would absorb 94% of the energy and the gypsum would absorb 6% of the energy. The surface area of each component after being ground by the grinding mill is a function of the energy absorbed and the grindability of the component absorbing the energy. As expected, gypsum is easier to grind than cement clinker. Consequently, since the cement clinker and the gypsum absorb equivalent energy, the gypsum will be ground finer, resulting in the gypsum having a higher surface area than the cement clinker. This is a desirable characteristic in ordinary Portland cement because gypsum acts as a retarder. As a retarder, it must be quickly soluble in water. Due to its high surface area after intergrinding, gypsum is highly soluble.

Conventional theory teaches to operate grinding mills to exploit this difference in surface area. This conventional method of exploiting the surface area difference between the cement clinker and the gypsum, or any other material that is interground, is termed “differential grinding.”

C. Test Methods

Various ASTM test methods are used in determining and quantifying the desirable and undesirable qualities of cementitious systems prepared from Portland and blended cements. Some of these test methods include: (1) ASTM C 227-04, which quantifies the effects of internal alkalies and can be used to determine if cementitious systems have the properties of low alkali functionality or alkali non-reactiveness; (2) ASTM C 1260-04, which can quantify the effects of external alkalies on aggregates, [C 1567 effect of external alkalies to] determines if a cementitious system is alkali resistant; (3) ASTM C 109-04 quantifies the compressive strength of a cementitious system; (4) ASTM C 1202-04 indirectly measures the permeability of the cementitious system to chloride ions' and (5) ASTM C 1012 which measures the resistance of a mortar mixture to external sulfate intrusion and attack resulting in deleterious expansion. ASTM test methods and standards including ASTM C 227-04, C 1260-04, C 1567, C 109-04, C 1202-04, C 150-04, C 1157-04, C 595-04, C 1012-04 and AASHTO T 277-04 and all other test methods or standards referenced herein are hereby incorporated by reference as if set forth in their entirety. The -04 following the ASTM test method number indicates that it is the ASTM method in effect during 2004.

Although the ASTM test methods are set out specifically, those skilled in the art may be aware of alternative methods which could be used to test for the referenced qualities or results. The only difference is that the results or qualities may be reported in a different manner wherein a conversion system could be used to give comparable results. Consequently, the invention should not be limited by the referenced test methods and the results thereof, but rather only to the claims as set forth below taking into account equivalent testing methods and results.

i. Effects on Concrete by Internal Alkalies

Aggregates used in concrete mixtures contain mineralogical components (soluble silica sites) that will react with hydroxyl ions in the concrete pore solution and form silica hydroxide gels. These silica hydroxide gel sites absorb the alkali ions producing alkali-silica gels in the concrete matrix. The alkali-silica gels are capable of absorbing water which causes the gels to swell in the confined spaces of the hardened concrete. The swelling creates internal stresses which result in premature cracking of the concrete. The above described reaction of silica hydroxide gels ultimately absorbing H₂O is termed “Alkali Silica Reactions” (ASR).

ASR is a significant factor in the deterioration of concrete. Current teachings suggest that fewer alkali ions in the cement will decrease the occurrence of ASR. As a result, the cement specified for concrete that would not be expected to experience ASR is currently limited to low alkali cement (less than about 0.40% to about 0.60% Na₂O equivalent). To manufacture a low alkali cement, either uniquely low alkali raw materials must be utilized, which is usually uneconomical, or the Portland cement must be processed in such a manner that the naturally occurring alkalies are evaporated and become concentrated in a byproduct stream known as cement kiln dust (CKD) which is removed from the manufacturing process and does not become part of the P.C. clinker.

As shown in FIG. 1, when the raw materials are being processed in the kiln system, the high alkali CKD evolves and is removed and transported to landfills as waste materials. In some systems, the amount of CKD removed amounts to as much as 15% of the total input of raw materials. Thus, a kiln system capable of producing a million tons of cement clinker a year could produce 150,000 tons or more of high alkali CKD.

Although low levels of alkali are already required in some instances, lower limits of alkali content are being proposed by both state and federal highway departments in hopes of further reducing ASR. Using the current method of producing Portland cement, lower levels will translate into additional CKD being removed and discarded, directly resulting in higher fuel use, faster depletion of the natural resources used as raw material feed stock, and increased expense for CKD removal and landfill, while possibly not solving the ASR problem if the alkali attack is from external sources such as deicing salts.

Additionally, the Environmental Protection Agency (EPA) is considering establishing substantial controls on the disposal of CKD, possibly classifying it as a hazardous waste which would be even more expensive for the cement producer to discard.

ASTMC 227-04 is utilized to determine the susceptibility of cementitious system/aggregate combinations to undergo ASR as measured by the change in length of mortar bars prepared from the cementitious system/aggregate combination. The aggregate utilized in ASTM C 227-04 can be either the job aggregate or a very reactive reference aggregate specified by ASTM known as pyrex glass.

By comparing the results of ASTM C 227-04 tests on cementitious systems to those of low alkali Portland cements, it can be determined whether the cementitious system has the property of low alkali functionality. If the cementitious system performs similar to a low alkali Portland cement in C 227-04, it is classified as having the property of low alkali functionality.

If the expansion in ASTM C 227-04 is less than about 0.06%, then the cementitious system not only has the property of low alkali functionality, but is also alkali non-reactive. The present invention is alkali non-reactive as the expansion is less than about 0.06%.

ii. Effects on Concrete by External Alkalies

External alkalies are such things as deicing salts, fertilizers or other chemicals placed on the lawn or ground next to the concrete, etc. External alkalies, like internal alkalies, can cause ASR expansion. Consequently, a need exists for a cementitious system that mitigates or at least minimizes ASR reactions due to external alkalies. A cementitious system that has these capabilities is termed an alkali resistant cementitious system.

ASTM C 1260-04 can be used to determine whether a cementitious system is resistant to external alkalies, and thus alkali resistant. Originally, ASTM C 1260-04 was developed to measure the susceptibility of aggregates, not the cementitious system, to alkali attack. In fact, C 1260-04 was originally thought to be independent of the type of cementitious system used. It has been found, however, that the cementitious systems of this invention can actually prevent the alkali from reacting with a highly reactive aggregate, such as a New Mexico aggregate, even under the very severe C 1260-04 test conditions.

ASTM C 1260-04 simulates external alkalies by soaking a mortar bar specimen in a hot alkali solution (80° C., 1N NaOH). ASTM C 1260-04 measures the change in length of mortar bar specimen to quantify the effects of the alkali on the mortar bar specimen. If the mortar bar specimen increases in size, ASR as a result of external alkalies has occurred, and therefore, external alkalies are adversely affecting the cementitious system. This means the cementitious system is not alkali resistant. Comparatively, if the mortar bar specimen has an expansion of less than about 0.08%, the cementitious system is alkali resistant. Alkali resistant cementitious systems offer protection from external alkalies far beyond that provided even by low alkali cementitious systems.

iii. Compressive Strengths

ASTM C 109-04 measures the compressive strength of hydraulic cement mortars. The compressive strength is the measured maximum resistance of a mortar specimen to axial compressive loading normally expressed as force per unit cross-sectional area. In prior art mortars, which included calcined clays, the early compressive strengths during the first 7 days, and most markedly in the first day, are highly diminished.

The diminished strength is undesirable for several reasons. Initially, delay in early strength development results in surface cracking due to evaporation. Secondly, jobs take longer because the concrete form must remain in place substantially longer, and finishing is delayed.

iv. Chloride Permeability

AASHTO T 277-04 or ASTM C 1202-04 determines the electrical conductance of concrete to provide a rapid indication of its resistance to the penetration of chloride ions. The greater the chloride ion permeability, the greater the chance that the reinforcing steel embedded in concrete will corrode and weaken as well as causing other undesirable chemical reactions to occur. Consequently, a need exists for a composition with low chloride ion permeability such that the steel reinforcing materials do not corrode.

v. Water Requirement

ASTM C 187-04 measures the amount of water required for mixing with a cementitious system to obtain a desired consistency. In prior art cementitious systems which contained calcined clays, the clays caused an increase in water demand over the water demand of ordinary Portland cement. The increased water demand was directly correlated to dramatic decreases in early compressive strengths of the prior art cementitious systems containing calcined clays with respect to ordinary Portland cement.

### Prior Art

Manufactured pozzolans are well-known for their application as mineral additives to Portland cement concrete. However, the reported results in literature clearly illustrate that prior art blended cements containing pozzolanic materials have undesirably depressed early compressive strengths. For example, ASTM C 595-04 classifies Portland cements containing pozzolans as Type P or Type IP. ASTM C 595-04 dictates that Type P should not be used in concrete construction where high early compressive strengths are required.

Literature also reports the use of fly ash interground with the cement clinker to address ASR problems. The resultant concrete had such a high water demand and dramatically decreased early compressive strengths that it was found to be undesirable as well as uneconomical.

The literature contains many examples of fly ash being used to supplement clay in the production of cement clinker. However, use of some Class C fly ash in concrete has frequently been considered to be problematical and leading to increased water demand when elevated levels of free calcium oxide, or crystalline C₃A are present in the fly ash, which can lead to lowered strength and greater permeability. The end effect is that fly ash pozzolans have historically been considered a low grade material. Consequently, there has been need for development for the most appropriate use of fly ash pozzolans as an additive to cement, and use in the formulation of concrete.

### SUMMARY OF THE INVENTION

A novel and premium grade pozzolan is disclosed which is superior for use with hydraulic cement. The pozzolan is a fly ash, preferably a Class F fly ash but possibly a Class C fly ash, meeting the requirements or ASTM C 618. The fly ash and a calcium sulfate component, such as gypsum or anhydrite or minerals on the continuum between gypsum and anhydrite, are interground in a grinding mill so that the mixture is finely ground to a fineness of at least 90% passing through a 45 micron sieve. The finely interground mixture fully meets the requirements of ASTM C618 for coal fly ash to be used as an additive with hydraulic cement. The blended pozzolan is a premium product and can be added to cement by a ready-mix plant operator to create a concrete having superior properties of compressive strength, ASR mitigation, improved sulfate resistance and lowered permeability when compared to typical Portland Cement concretes.

Fly ash meeting the requirements of ASTM 618 Class F or Class C are specified and preferably Class F for use in the invention.

### BRIEF DESCRIPTION OF THE DRAWING

FIG. 1 is a schematic of the current day process of preparing ordinary Portland cement.

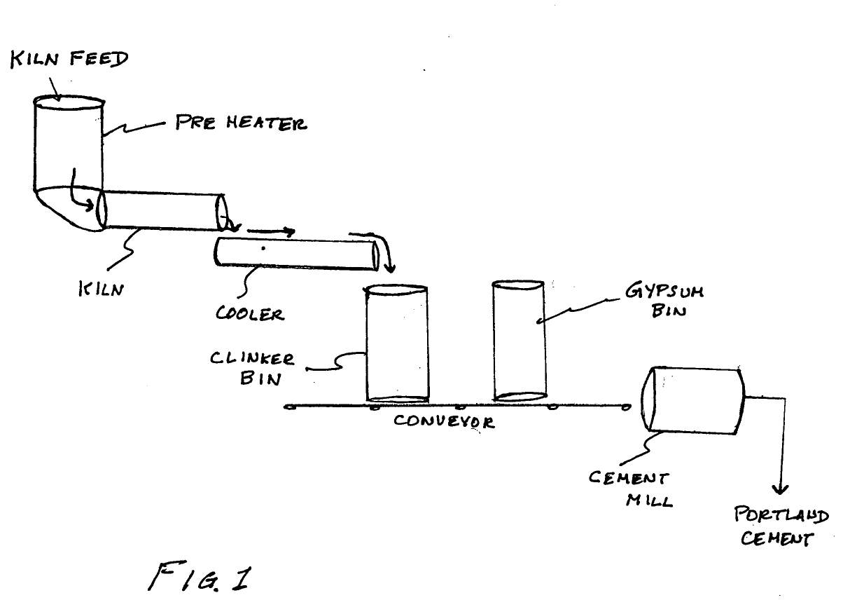

FIG. 2 is a schematic of the process of preparing a blended pozzolan of the present invention.

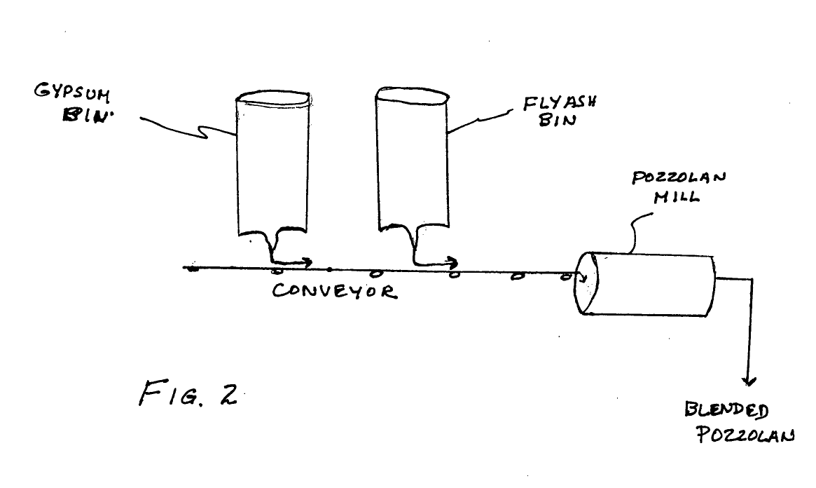

FIG. 3 is a particle size distribution chart of fly ash shown “as received”, ground for 60 minutes and an intermediate grind.

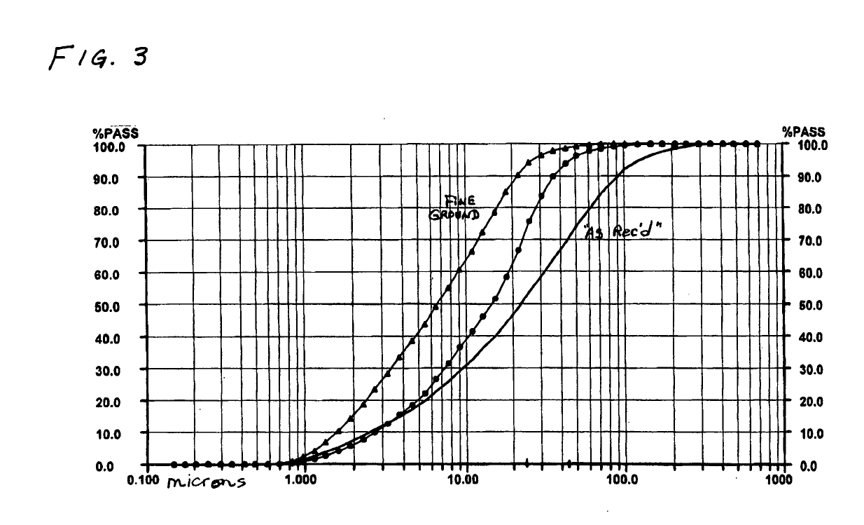

### DESCRIPTION OF THE PREFERRED AND ALTERNATE EMBODIMENTS

The invention comprises a novel blended pozzolan and a concrete composition made using the novel blended pozzolan. This invention is a premium additive to cement for making concrete, and provides a concrete having improved strength, ASR mitigation, improved sulfate resistance and lowered permeability.

This disclosure uses atomic element symbols as used in the cement elements are still further abbreviated and are different from standard element symbols. Herein, C means calcium, \overline{S} is sulfur, S is silica, F is iron (ferrite) and A is aluminum.

Portland cement (PC) hydration consists of the reaction of PC phases with water to form new reaction products which interconnect to form a rigid, hardened mass. This mass can exhibit different permeability and strength characteristics dependent upon the reactivity of the cement used, the water-to-cement reaction of the system, and the temperature and humidity at which the materials are exposed and cured. The primary PC phases are C₃S, C₂S, C₃A and C₄AF. The calcium silicates (C₃S, C₂S) react with water to form calcium silicate gel (C—S—H) and calcium hydroxide (CH) by nucleation and precipitation from the solution surrounding the hydrating cement grains. Tri-calcium aluminates (C₃A) and tetra-calcium alumino-ferrite (C₄AF) react with water to form various calcium ratio hydrates and/or react with sulfur (typically in the form of gypsum) to form calcium sulfo-aluminate hydrates (C₄A\overline{S}H₁₂ or C₆A\overline{S}₃H₃₂) referred to as mono-sulfo-aluminate, and ettringite, respectively.

In a blended cement system, or when pozzolans are added to PC as a mineral admixture, the kinds of reaction products formed are similar to the reaction products in PC hydration, but they are in different ratio, and can produce considerably different physical properties of the hardened mass. These properties can either enhance or detract from the long term durability potential of the paste portion of the concrete. Pozzolans, by definition, are silicates or alumino-silicates that when mixed with water and a source of calcium, typically calcium hydroxide from the PC, forms compounds possessing cementitious properties, such as C—S—H (adapted from ASTM C 125). The aluminum which is dissociated from the alumino-silicate pozzolan is then left to react with available lime to form calcium aluminate hydrates or calcium alumino-silicate hydrates such as C₄AH₁₃, C₂AH₈, C₂ASH₈ (strätlingite), or C₃AH₆ (hydrogarnet). The phase equilibrium of the systems CaO—Al₂O₃—H₂O and CaO—Al₂O₃—SO₃-H₂O (standard symbols used) can be affected by the presence of alkaline (such as Na and K) and by sulfate ions in the hydrating solution.

The product claimed in this patent goes beyond previously published work to enhance the properties of a PC/Pozzolan blended cementitious system by manipulating the particle size distribution of the pozzolan and by intergrinding a source of sulfate (preferably calcium sulfate) into the alumino-silicate to force the reaction products ratio strongly towards the calcium sulfo-aluminate hydrate phase equilibrium. This is considerably and uniquely different from other cementitious systems which cannot optimize those properties. This will impart improvements in the inherent strength generating potential of the combination (as demonstrated by C 109 data), as well as improving the sulfate resistance of the system (as demonstrated by C 1012 data). This is accomplished by significantly changing the sulfur to aluminum ratio of the blended pozzolan, along with changing the surface area of the pozzolan. These changes in fineness and sulfur/aluminum ratio also impart microstructural changes to the hydrating cementitious system which reduce the capillary pore structure, reducing permeability and improves long term chemical shrinkage by producing reaction products which are of greater absolute volume and are chemically and physically more stable compounds. Historically, Portland Cement/Pozzolan combinations have always undersulfated with respect to the sulfur-alumina ratio. The added alumina brought in by the pozzolan must be balanced with sulfate or volume stability and strength are compromised. The most desirable amount of sulfate interground into the blended pozzolan is specific to the total alumina of the system which will vary pozzolan to pozzolan. Therefore, the gypsum/pozzolan ratio must be predefined, hence the development of this product for this patent claims. When the calcium ion content is significantly depleted from uptake by the pozzolanic reactions, zeolite like structures can develop (sodium-alumino-silicate hydrates) which have a greater capacity for cation exchange complexing. A reduction in permeability also occurs and can reduce moisture movement through a concrete system which will reduce drying shrinkage and efflorescence potential.

The preferred blended pozzolan uses a fly ash meeting the requirements of ASTM C618 for Class F fly ash obtained from the combustion of anthractic or bituminous coal. The other significant component is a calcium sulfate containing component. This can be gypsum or anhydrate, or any of the calcium sulfate minerals on the continuum between gypsum and anhydrate. The fly ash and calcium sulfate component are mixed in the approximate proportion of 93% fly ash to 7% gypsum and interground so that a finely ground, interblended material results. The fineness is preferably such that at least 90% passes through a 45 micron sieve.

The proportion of fly ash to calcium sulfate component is selected to optimize sulfate resistance, volume stability, alkali silica reaction mitigation and compressive strength.

Silica fume may be added to the fly ash/calcium sulfate composition. An appropriate proportion of silica fume may be determined to address alkali/silica reaction and permeability properties desired, however, the addition of silica fume can undesirably increase water demand. Although silica fume is expensive, its use can be beneficial in a premium product such as the present invention. Ideally, the silica fume is interground with the fly ash/calcium sulfate component so as to meet the fineness requirement set forth above. Silica fume will react with Ca(OH)₂ to form C—S—H. It is known that the inter-layer water of the C—S—H contributes greatly to shrinkage potential, and that when depletion of calcium (needed for calcium sulfo-aluminate hydrate production) occurs, it requires an elevated gypsum addition rate to be designed into the system to supply the necessary calcium and sulfate availability. This correction to the hydrate ratios forms more mono-sulfo-aluminate hydrate, and ettringite, which gives this system the novel and unprecedented performance claimed.

An air entraining agent may also be added to the mixture. A suitable air entraining agent is Daravair (a registered trademark of the W.R. Grace Company). The air entraining agent minimizes the affect of the residual carbon content of the fly ash which historically causes an air-detraining property in a concrete system.

The pozzolan mixture of the present invention is used as a substitute for a portion of the cement in a concrete mixture. Ideally, the blended pozzolan would comprise a 25% pozzolan to cement ratio; however, beneficial results of the blended pozzolan could be obtained with as low as a 10% ratio.

The samples below illustrate and discuss various compositions of cement and a blended pozzolan made sequentially in accordance with the invention (fineness changes first then sulfate changes):

Sample 1

This sample comprised a control consisting of a Type I/II cement made at Ash Grove Cement Company's Chanute, Kansas plant. The cement displayed on ASTM C 187 normal consistency of 25.0, an ASTM C 191 Vicat time of set of 104 minutes initial set and 165 minutes final set. It had an ASTM C185 air content of 6.3%. ASTM C 109 compressive strength cubes were:

| | | |
|---|---|---|
| 1 | day | 2380 |
| 3 | days | 3930 |
| 7 | days | 4820 |
| 28 | days | 6290 |
| 56 | days | 6620 |

Sample 2

This sample combined a 25% Boral Class F fly ash replacement with the control cement. The fly ash was used for this sample “as received.” The cement/fly ash pozzolan mixture displayed an ASTM C 187 normal consistency of 23.4, an ASTM C 191 Vicat time of set of 156 minutes initial and 223 minutes final set. An ASTM C 185 air content of 4.7% was determined, then an air entraining agent was added consisting of 0.2 cc Daravair 1400 which resulted in 14.6% entrained air content. The fly ash was not ground but was analyzed for size as follows:

| | |
|---|---|
| #500 Mesh (25 Microns) Retained %/Passing % | 43.57/56.43% |
| #325 Mesh (45 Microns) Retained %/Passing % | 28.67/71.33% |

ASTM C 109 Compressive Strength Cubes were:

| | | |
|---|---|---|
| 1 | day | 1650 |
| 3 | days | 2780 |
| 7 | days | 3690 |
| 28 | days | 5050 |
| 56 | days | 5710 |

Sample 3

This sample combined a pozzolan consisting only of Boral Class F fly ash finely ground to determine optimal grinding. This was a 25% fly ash/cement replacement, ground for 30 minutes in a ball mill. The cement displayed an ASTM C 187 normal consistency of 24.4, and an ASTM C 191 Vicat time of set of 148 minutes initial and 229 minutes final set. There was an ASTM C 185 air content of 1.7% this reduction in air content illustrates why an air entraining agent is needed or desirable when a greater surface area of pozzolan is opened up by the grinding.

Sieve Analysis Showed:

| | |
|---|---|
| #500 Mesh (25 Microns) Retained %/Passing % | 9.37/90.63% |
| #325 Mesh (45 Microns) Retained %/Passing % | 0.40/99.57% |

ASTM C 109 Compressive Strength Cubes were:

| | | |
|---|---|---|
| 1 | day | 1730 |
| 3 | days | 3010 |
| 7 | days | 4060 |
| 28 | days | 5770 |
| 56 | days | 6880 |

This sample of moderately finely ground fly ash demonstrated an increase over ordinary Portland cement in later compressive strength of approximately 4% at 56 days.

Sample 4

This sample combined a pozzolan consisting only of Boral Class F fly ash finely ground to determine optimal grinding. This was also a 25% fly ash/cement replacement, ground for 60 minutes in a ball mill. The cement displayed an ASTM C 187 normal consistency of 25.2 and an ASTM C 191 Vicat time of set of 150 initial and 207 minutes final set. There was an ASTM C 185 air content of 2.4%, improved with Daravair to 10%.

Sieve Analysis Showed:

| | |
|---|---|
| #500 Mesh (25 Microns) Retained %/Passing % | 1.09/98.91 |
| #325 Mesh (45 Microns) Retained %/Passing % | 0.09/99.91 |

ASTM C 109 Compressive Strength Cubes were:

| | | |
|---|---|---|
| 1 | day | 2070 |
| 3 | days | 3560 |
| 7 | days | 4530 |
| 28 | days | 7210 |
| 56 | days | 8100 |

The Class F fly ash pozzolan, when finely ground to more than 99% passing through a 45 micron sieve, exhibited early strengths slightly lower than the control Portland cement; however, by 28 days, compressive strengths were greater than that of the control cement and by 56 days the combination with fine ground fly ash showed a 22.4% increase of the control cement and 41.8% increase over the fly ash/cement combination where the fly ash fineness was used “as received”, cement with a finely ground Type F fly ash component of 25% demonstrated a 41.85% improvement in strength over cement only.

Because of the finer material, the resultant cement or concrete composition is more dense and less permeable, and less subject to intrusion by external alkalis, chlorides and sulfates such as those contained in road salts.

Although the invention may be embodied in various forms, the scope of the invention is not so limited, and is limited only by the claims.

1. A blended pozzolan for use with hydraulic cement and comprising:
a) fly ash meeting the requirements of ASTM C 618 Class C or F;
b) a calcium sulfate component; and
c) the fly ash and the calcium sulfate component being interground to a fineness of at least 90% passing through a 45 micron sieve and meeting the requirements of ASTM C 618 for coal fly ash.

2. The blended pozzolan set forth claim 1 including silica fume interground with the fly ash and calcium sulfate component.

3. The blended pozzolan set forth in claim 1 wherein the calcium sulfate component is gypsum.

4. The blended pozzolan set forth in claim 1 including an air entraining agent.

5. The blended pozzolan set forth in claim 1 wherein there is an approximate proportion of 93% fly ash and 7% calcium sulfate component.

6. The blended pozzolan set forth in claim 1 wherein the proportion of fly ash to calcium sulfate component is selected to optimize sulfate resistance, volume stability, alkali silica reaction mitigation and compressive strength.

7. A concrete composition comprising:
a) blended pozzolan formed by intergrinding fly ash with a calcium sulfate component to a fineness of at least 90% passing through a 45 micron sieve;
b) hydraulic cement meeting the requirements of ASTM C 150, C 595 or C 1157;
c) aggregate meeting the requirements of ASTM C 33;
d) water meeting the requirements of ASTM C 04; and
e) the above components producing a concrete having the uniquely improved strength, alkali-silica-reactivity mitigation, improved sulfate resistance and lowered permeability.

8. The concrete composition, set forth in claim 7 wherein the blended fly ash is a Class F fly ash.

9. The concrete composition, set forth in claim 7 wherein the calcium sulfate component is gypsum.

10. A blended pozzolan for use with hydraulic cement and comprising:
a) fly ash meeting the requirement of ASTM C 618 Class C or F;
b) a calcium sulfate component; and
c) the fly ash and calcium sulfate component being interground in a proportion selected to optimize sulfate resistance, volume stability, alkali silica reaction mitigation and compressive strength, the intergrinding being to a fineness of at least 90% passing through a 45 micron sieve, the blended pozzolan meeting the requirement of ASTM C 618 for coal fly ash.
